(19) United States
(12) Patent Application Publication
(10) Pub. No.: US 2002/0116525 A1
(43) Pub. Date: Aug. 22, 2002

(54) Method for automatically directing browser to bookmark a URL other than a URL requested for bookmarking

(76) Inventors: Marcia L. Peters, Durham, NC (US); John R. Hind, Raleigh, NC (US); Soumitra Sarkar, Cary, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/784,881

(22) Filed: Feb. 16, 2001

(51) Int. Cl. G06F 15/16

(52) U.S. Cl. 709/242; 709/243; 709/245

(57) ABSTRACT

The present invention provides a method for automatically bookmarking a URL specified by a web author when a user of a web browser attempts to bookmark a different page or when a process updates bookmarks based on either the HTTP 301 return code or the HTML meta refresh markup. In accordance with the present invention, a web page author places an “alternate bookmark directive” in the page (HTML or XML format) associated with a particular URL. When this “alternate bookmark directive” in the HTML or XML file is received by the web browser or by a process updating bookmarks, and the user of the browser attempts to bookmark the URL being viewed or the process is verifying a bookmark, then either the browser is instead directed to bookmark the alternate URL from the tag or the process modifies the bookmark being verified using the alternate URL from the tag. In a preferred embodiment, the bookmarked page being viewed or verified is an internal web page of the website, and the alternate bookmark directive directs the browser to bookmark the URL for the home page of the website or the verification process to update the bookmark to the URL for the home page of the website.

### BACKGROUND OF THE INVENTION

1. Field of the Invention

This invention relates generally to information retrieval in a computer network. More particularly, it relates to an improved method for directing a Web browser to bookmark a URL different than the URL requested for bookmarking by the user of the Web browser.

2. Description of the Related Art

It is well known to couple computer systems into a network of computer systems so that the collective resources available within the network may be shared among users. The Internet has brought this sharing of computer resources to a Much wider audience.

The World Wide Web, or simply “the Web”, is the Internet's information retrieval system; it is the most commonly used method of transferring data in the Internet environment. Client machines accomplish transactions to Web servers using the Hypertext Transfer Protocol (HTTP), which is a known application protocol providing users access to files (e.g., text, graphics, images, sound, video) using a standard page description language such as the Hypertext Markup Language (HTML). HTML provides basic document formatting and allows the developer to specify “links” to other servers and files. In the Internet framework, a network path to a server is identified by a Uniform Resource Locator (URL) having a specific syntax for defining a network connection.

Retrieval of information is generally achieved by the use of an HTML-compatible “browser”, e.g., Netscape Navigator, at a client machine. Web browsers have become the primary interface for access to many network and server services. When the user of the browser specifies a link via a URL, the client issues a request to the domain name service (DNS) to map a hostname in the URL to a particular Internet address (called an IP address) at which the server is located. The naming service returns a list of one or more IP addresses that can respond to the request. Using one of the IP addresses, the browser establishes a connection to a server. If the server is available, it returns a document or other object (often formatted according to HTML, which is the standard for Web page description, or more recently in XML with the help of an ancillary style sheet containing presentation instructions).

The entry of the URL in the entry field of a browser can be a difficult task for many users. While the URL for the main Web page of a major company can be relatively brief, e.g., http://www.ibm.com/, subsidiary pages can have very lengthy and non-intuitive URLs. As an example, the URL for the “Small Business Center” page, an internal page accessible from the main IBM web page, is as follows:

http://www-1.ibm.com/businesscenter/us/smbusapub.nsf/detailcontacts/SBCenter5988. Recognizing the difficulties involved, the developers of browsers have provided a useful means of returning to a favorite URL, by including with the browser the ability to create and store “bookmarks” (also called “favorites”) in the browser program.

Web browsers offer many options in the user interface for creating a bookmark list. Basic options let the user add and access a page through a pop-up menu on the location toolbar or through a menu pulldown from the main menu bar. A simple way to add a bookmark for a favorite page is to key in the desired URL to travel to the page and, once there, open the “Bookmarks” menu and choose the “Add Bookmarks” selection. This set of actions adds the URL of the current page as an item in the “Bookmarks” menu. Alternatively, instead of keying in the URL to travel to a page, the user might click on a “hyperlink” in a well known manner to travel to the Web page identified by the hyperlink. For example, from a home page, the user might click on a hyperlink to travel to an internal page within the website. Once on the desired page, the user can add the bookmark as described above.

Each browser has its own unique format for bookmarks. Netscape browsers, for example, place bookmarks in an HTML file as a table entry. The table entry may include other fields in addition to the URL to assist in the bookmark management process provided by the browser. Thus, the following is an example of a Netscape bookmark entry:

<DT><A HREF=“http://st7.yahoo.net/alix/” ADD_DATE=“Aug.-30-1999” LAST_VISIT=“Sep.-23-2000” LAST_MODIFIED=“Dec.-22-1999”>Alix Sales-Memory Cards</A>This bookmark directs the browser to the URL “http://st7.yahoo.net/alix/” and also carries the date on which the bookmark was added to the bookmark file (ADD_DATE- “Aug.-30-1999”); the date the URL was last visited (LAST_VISIT=“Sep.-23-2000”; and the date the URL was last changed (LAST_MODIFIED=“Dec.-22-1999”) (the actual format used for designating the date may differ; the familiar “month-day-year” format shown is for the purpose of example only). The “name” of the bookmark, which is displayed to the user in the bookmark menu, is “Alix Sales—Memory Cards.”

The HTTP standard is the protocol used by a web server and a client browser to communicate over the Internet. HTTP has been in use by the World Wide Web global information initiative since 1990 and is defined in a series of specifications identified by their “request for comments” (RFC) number. For example, HTTP 1.0 is defined in “RFC 1945” published in May of 1996. While various other updates have been developed, e.g., HTTP 1.1 defined in RFC 2616, Jun., 1999, HTTP 1.0 is still the standard that is predominantly in use today. In the discussion below, HTTP 1.0 is assumed, unless indicated otherwise. However, the manner in which this invention may be applied when using HTTP 1.1 or other standards will be obvious from the description or may be learned by practice of the invention.

Using the HTTP standard, information is exchanged between the browser and the server using “headers.” A typical HTTP transaction consists of a header followed optionally by an empty line and some data. The header will specify such things as the action required of the server or the type of data being returned, or a status code. The header contained in an HTTP transaction sent from a server in response to a transaction received from a browser is called a “response header.”

Web authors sometimes use the HTML “META” tag to direct the browser to simulate receiving HTTP fields as a way of specifying a redirected URL “location”. Essentially, the web author can use the META tag in an HTML document located at a particular URL (the original target URL) to direct the browser to instead retrieve the document found at the URL identified in connection with the META tag.

For redirecting browsers to a new URL when a particular URL is invalid, a redirect markup technique, referred to as a “Meta Refresh,” is used by web authors. The following is an example of HTML code for a Meta Refresh tag which “tells” the browser, as it renders the containing HTML web page, to react as if the HTTP response (“HTTP-EQUIV”) had a refresh header field containing “CONTENT”, a value which, in this example, would cause the browser to reload and render the page in 2 seconds from the specified URL:

<META HTTP-EQUIV=“REFRESH” CONTENT=“2; URL=HTTP://www.someware.com/new-page.html”>

This method serves the purpose of redirecting the browser to the URL identified in the Meta Refresh tag, and is used to redirect the browser when the original URL is permanently or temporarily invalid.

In commonly assigned, co-pending U.S. patent application Ser. No. ______, filed concurrently with the present application (and incorporated fully herein by reference), a self-maintaining web browser bookmark model is disclosed in which bookmarks may be updated automatically by the user of a browser or by a batch process which periodically updates bookmarks, whenever a redirect (return code or meta-tag) is received by the browser. In brief, when the browser receives a redirect, the new URL identified in the redirect automatically replaces the URL in the original bookmark file. In a preferred embodiment, the original URL is saved for possible access, for example, if the redirect is temporary and expires.

When Web authors design websites, great attention is given to development of the first page of the website, commonly referred to as the “home page”. There are a variety of reasons for spending a significant amount of time and resources developing the home page. Specifically, the home page of a website is the first page that a Web user will be directed to when they, for example, read a company website address from written literature, business cards, and the like and/or click on a hyperlink to a company website. As the entry point into a website, a home page will often display navigation aids and advertising content, and may also include visitor counting and tracking mechanisms. Further, some sites require users to log in to the site when accessing it, and this access is typically obtained from the home page. The website owner, therefore, would typically prefer that all users initially access the site through the home page.

With the advent of bookmarking, however, frequently a user will bookmark an internal page of a website, i.e., a secondary page which is accessed from a link displayed on the home page.. The user may “drill down” several levels of the website until finding a particular page of interest. Commonly, the user will then bookmark this site on the browser being used to access the website. While convenient for the user of the browser, the website owner, as noted above, has good reasons to have users always access their site through the home page. However, standard bookmarks only allow for bookmarking of the page designated for bookmarking by the user.

Accordingly, a need exists for a method by which a web author can “force” the bookmarking of a URL other than the URL of a web page that the user of the browser wants to bookmark.

### SUMMARY OF THE INVENTION

The present invention provides a method for automatically bookmarking a URL specified by a web author when a user of a web browser attempts to bookmark a different page or when a process updates bookmarks based on either the HTTP 301 return code or the HTML meta refresh markup. In accordance with the present invention, a web page author places an “alternate bookmark directive” in the page (HTML or XML format) associated with a particular URL. When this “alternate bookmark directive” in the HTML or XML file is received by the web browser or by a process updating bookmarks, and the user of the browser attempts to bookmark the URL being viewed or the process is verifying a bookmark, then either the browser is instead directed to bookmark the alternate URL from the tag or the process modifies the bookmark being verified using the alternate URL from the tag. In a preferred embodiment, the bookmarked page being viewed or verified is an internal web page of the website, and the alternate bookmark directive directs the browser to bookmark the URL for the home page of the website or the verification process to update the bookmark to the URL for the home page of the website.

### BRIEF DESCRIPTION OF THE DRAWINGS

FIG. 1 is a flowchart illustrating the basic steps performed in accordance with the present invention;

FIG. 2 illustrates a representative workstation hardware environment in which the present invention may be practiced; and

FIG. 3 illustrates a data processing network in which the present invention may be practiced.

### DETAILED DESCRIPTION OF THE PREFERRED EMBODIMENTS

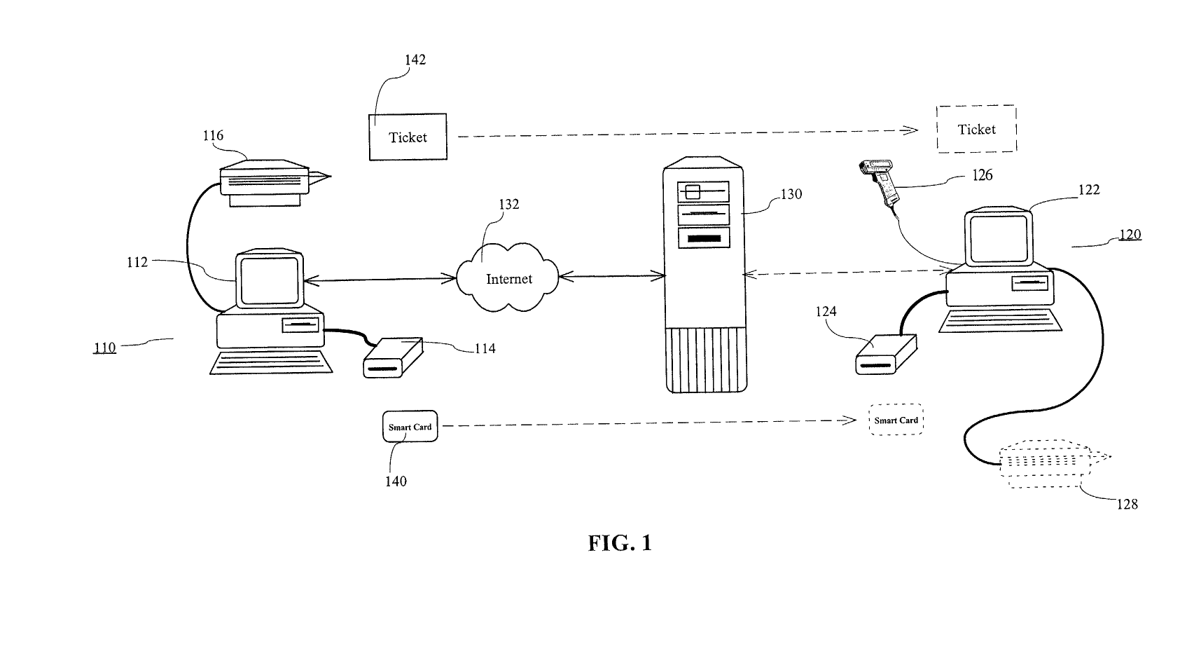

FIG. 1 is a flowchart illustrating the basic steps of the present invention, taken from the perspective of the user of a Web browser. At step 110, a user using a browser selects a target URL to direct the browser to a particular Web page. For example, the user may click on a hyperlink to the target URL, or may manually type in the URL in a known manner. At step 112, in accordance with conventional methods, the browser is pointed, via the Internet, to the selected URL and accesses the page associated therewith. At step 114, the user directs the browser to bookmark the URL in a known manner. At step 116, a determination is made as to whether or not the web page associated with the selected URL contains an alternate bookmark directive. There are a number of markup techniques by which such a directive could be added to the page depending on the page format. In our preferred embodiment, the directive would be an instance of HTML meta data with an agreed-to name that carried the URL to be bookmarked or an XML name space extension named entity with an attribute value that carried the URL to be bookmarked.

If the selected URL does not contain an alternative bookmark directive, at step 118 the target URL is bookmarked in a known manner. If, however, at step 116 a determination is made that the selected URL does contain an alternative bookmark directive, then at step 120 the alternate bookmark identified in the alternate bookmark directive is bookmarked, instead of the target bookmark.

The above-described steps can be implemented using standard well-known programming techniques. The novelty of the above-described embodiment lies not in the specific programming techniques but in the use of the steps described to achieve the described results.

Use of the method of the present invention enables a webmaster to “force” a constant value for any page related to the site being managed by the webmaster that a user bookmarks. Forcing users to access a site through the “front door” or “home page” of a website is desirable because, among other things, it enables the use of visitor-counting and tracking mechanisms, forces the user to view advertising content and navigation mechanisms that appear on the home page, and forces the use of authentication and login procedures where applicable. There are no equivalent HTTP protocols to perform this function.

In a preferred embodiment, this forcing step is implemented by including a novel “META” tag in the HTML or XML for an internal page with a directive which tells the browser to use a specific URL rather than the current URL if the user creates a bookmark for the page being displayed and, also, that if a bookmark was used to directly access the page then it should be updated to use the specified URL instead of the URL of the internal page. For example, the directive as an HTML markup might look like:

<meta name=“BOOKMARK_AS” content=“http://www.ibm.com/” display=“IBM Corporation Home Page”>and the XML markup for the directive might look like:

<meta:BOOKMARK_AS content=“http://www.ibm.com/” display=“IBM Corporation Home Page”>Each of these causes any attempt at bookmarking the current page to bookmark the www.ibm.com URL. The browser will interpret the respective markup-tag and if the user tries to bookmark the current page, the browser will substitute the web page URL identified in the respective tag's attribute value. As a result, all users will enter such a site through the “front door” only when they use the bookmark created from the internal page. This embodiment may alternatively be implemented using fields in the HTTP header (for example: “BOOKMARK^{—}AS:http://www.ibm.com”). This latter embodiment is less preferred, however, because it would be unlikely to be used for the same reasons HTTP redirect return codes are not used.

In the above-described embodiment, the bookmarking process is an interactive model in which bookmark updating occurs during the browsing process upon direction from the user. However, in an alternative embodiment, a “batch model” can also be utilized. In accordance with this alternative embodiment, a batch program can be invoked periodically (e.g. on a time-scheduled basis) or each time the browser is launched. As an example, the batch program could cause the browser to automatically check all bookmarks stored on the browser. If a web master decides, after initial publication of an internal web page, to designate the page with “forced bookmarking” as described above, then when the batch program goes through the checking process, it will “discover” the forced bookmark and update the stored bookmark accordingly.

Following is an example of typical steps that would be performed by a batch bookmark program involving meta tags in HTML (including redirection logic as discussed in co-pending application Ser. No.______, discussed above, as well as meta tag processing):

1. User of batch bookmark update program specifies location of bookmark file, and browser type.

Browser type used to identify bookmark file format.

2. Batch program opens bookmark file, creates a temporary output file.

3. For each bookmark in the file, it performs the following logic in steps 3a, 3b, and 3c.

a. Parse the bookmark entry, extracting the URL it refers to.

b. Send an HTTP GET request to that URL, building the protocol header, etc.

c. Process the HTTP response. There are three cases to be handled.

i. If it was a “redirect” response (HTTP 301 return code or a 200 return code with an HTML document containing the redirect meta-tag sequence), then the site has moved, and the body of the response contains the URL of the new site. Modify the in-memory copy of the bookmark with the new URL and jump to 3b above.

ii. Else, it was some other response indicating that the URL is permanently unavailable. In that case, the bookmark is invalid.

iii. Else, it was a valid response (HTTP response code 200). The in-memory bookmark is valid. However, there might be meta-tags in the HTML returned to force the bookmarking. To check for that, parse the HTML content returned in the response, looking for meta tags that force bookmarking. There are two cases to be handled.

A. If there is such a meta tag, the bookmark should be modified. Write out the new bookmark, referencing the URL in the meta tag that the page author wants to assign to the bookmark.

B. Else there is no such meta tag, and the in-memory bookmark should be preserved. Copy it to the temporary output file.

4. Close temporary output file. Delete bookmark file (or save as a historical back-up file). Rename temporary output file as original bookmark file.

The above bookmark batch program steps are provided for the purpose of example only. It is understood that there are many different batch programs that could be invoked to automatically, either on a periodic basis or upon the occurrence of a predetermined event, cause the forced bookmarking of the present invention to be performed.

As with any new browser function, the first implementing product would choose the details of the tagging technique to convey the alternative bookmark directive and would provide web authors with this information so they could take advantage of the new function. Over time, other products choosing to also provide the function would recognize this tagging convention in their product code. Such a possible convention is shown in the above example, namely that an HTML author inserts a “meta” element having a “name” attribute with the value of “BOOKMARK₁₃ AS” and a “content” attribute having the value of the URL to be used into the HTML file representing the web page to indicate to the browser that the respective URL should be used when bookmarking the page.

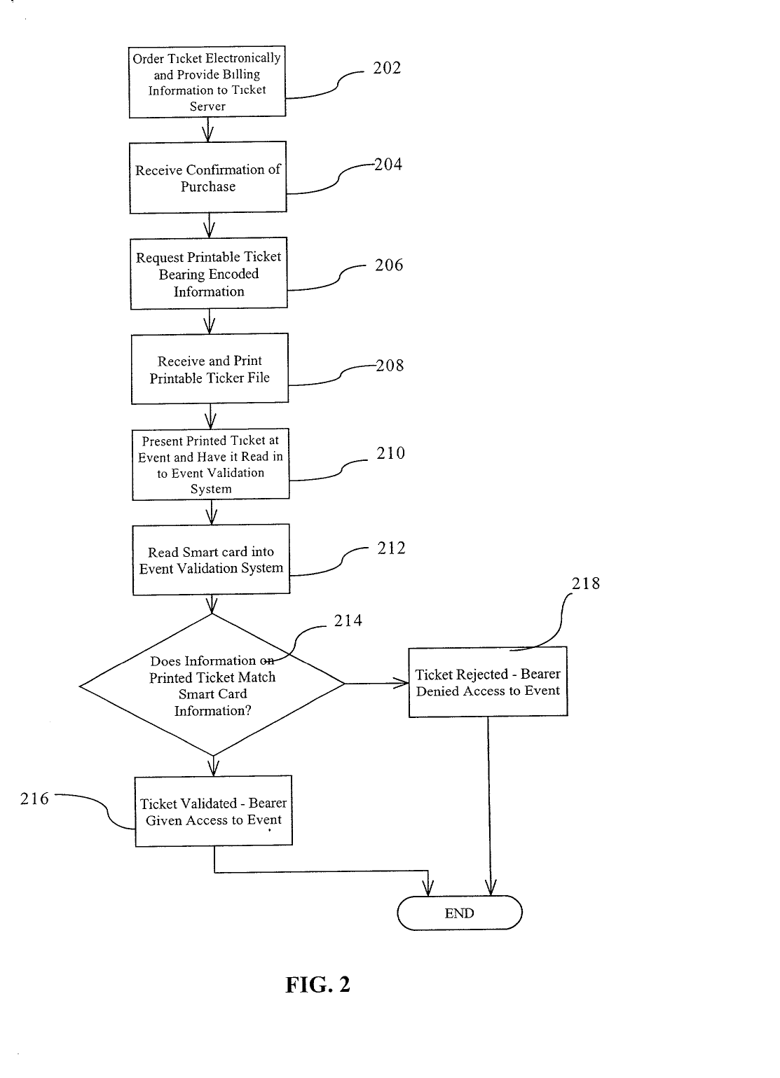

FIG. 2 illustrates a representative workstation hardware environment in which the present invention may be practiced. The environment of FIG. 2 comprises a representative single user computer workstation 200, such as a personal computer, including related peripheral devices. The workstation 200 includes a microprocessor 212 and a bus 214 employed to connect and enable communication between the microprocessor 212 and the components of the workstation 200 in accordance with known techniques. The workstation 200 typically includes a user interface adapter 216, which connects the microprocessor 212 via the bus 214 to one or more interface devices, such as keyboard 218, mouse 220, and/or other interface devices 222, which can be any user interface device, such as a touch sensitive screen, digitized entry pad, etc. The bus 214 also connects a display device 224, such as an LCD screen or monitor, to the microprocessor 212 via a display adapter 226. The bus 214 also connects the microprocessor 212 to memory 228 and long term storage 230 which can include a hard drive, tape drive, etc.

The workstation 200 communicates via a communications channel 232 with other computers or networks of computers. The workstation 200 may be associated with such other computers in a local area network (LAN) or a wide area network, or the workstation 200 can be client in a client/server arrangement with another computer, etc. All of these configurations, as well as the appropriate communications hardware and software, are known in the art.

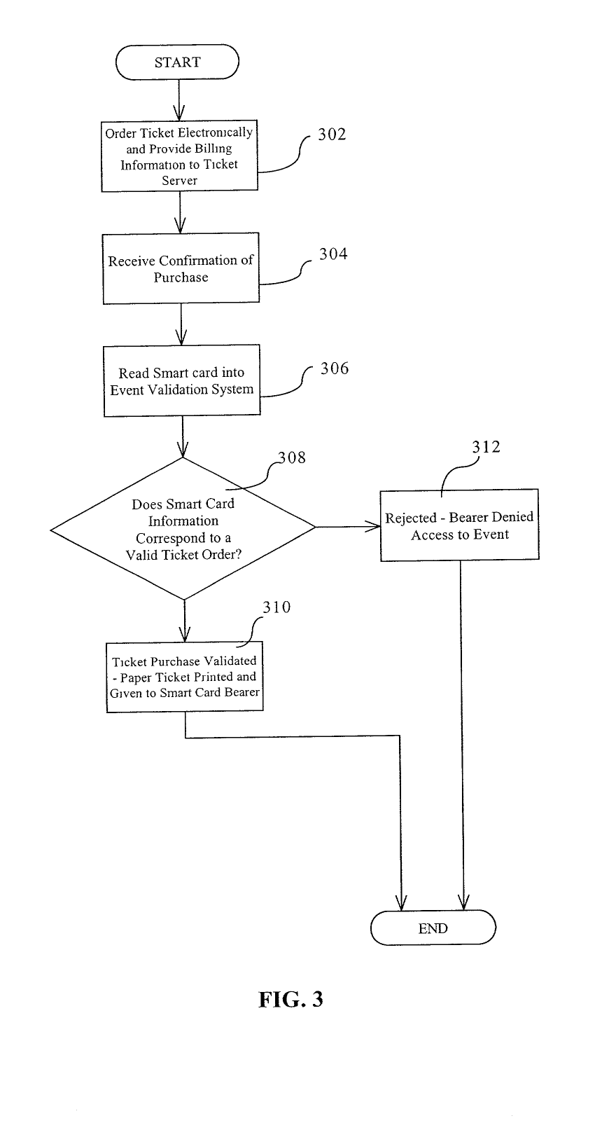

FIG. 3 illustrates a data processing network 340 in which the present invention may be practiced. The data processing network 340 includes a plurality of individual networks, including LANs 342 and 344, each of which includes a plurality of individual workstations 200. Alternatively, as those skilled in the art will appreciate, a LAN may comprise a plurality of intelligent workstations coupled to a host processor.

Still referring to FIG. 3, the data processing network 340 may also include multiple mainframe computers, such as a mainframe computer 346, which may be preferably coupled to the LAN 344 by means of a communications link 348. The mainframe computer 346 may be implemented utilizing an Enterprise Systems Architecture/370, or an Enterprise Systems Architecture/390 computer available from the International Business Machines Corporation (IBM). Depending on the application, a midrange computer, such as an Application System/400 (also known as an AS/400) may be employed. “Enterprise Systems Architecture/370” is a trademark of IBM; “Enterprise Systems Architecture/390”, “Application System/400” and “AS/400” are registered trademarks of IBM.

The mainframe computer 346 may also be coupled to a storage device 350, which may serve as remote storage for the LAN 344. Similarly, the LAN 344 may be coupled to a communications link 352 through a router 354 and a communications link 356 to a gateway server 358. The gateway server 358 is preferably an individual computer or intelligent workstation which serves to link the LAN 342 to tile LAN 344.

Those skilled in the art will appreciate that the mainframe computer 346 may be located a great geographic distance from the LAN 344, and similarly, the LAN 344 may be located a substantial distance from the LAN 342. For example, the LAN 342 may be located in California, while the LAN 344 may be located in Texas, and the mainframe computer 346 may be located in New York.

Software programming code which embodies the present invention is typically stored in permanent storage of some type, such as the permanent storage 230 of the workstation 200. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of causing a web browser to bookmark an alternative URL rather than a target URL, comprising the step of:
inserting an alternative bookmark directive in an encoded web page representation associated with said target URL, said alternative bookmark directive causing said web browser to bookmark said alternative URL instead of said target URL when a user of said web browser attempts to bookmark said target URL.

2. A method as set forth in claim 1, wherein said encoded web page representation is encoded in HTML.

3. A method as set forth in claim 1, wherein said encoded web page representation is encoded in XML.

4. A method as set forth in claim 1, wherein said web browser periodically checks all URLs associated with bookmarks stored by said browser to determine if any of said URLs have an alternative bookmark directive associated therewith and, if so, causing said web browser to bookmark said alternative URL instead of the target URL.

5. A method of causing a web browser to bookmark an alternative URL rather than a target URL, comprising the steps of:
inserting an alternative bookmark directive in an encoded web page associated with said target URL;
accessing said target URL using said web browser; and
directing said web browser to bookmark said target URL, said alternative bookmark directive causing said web browser to bookmark said alternative URL instead of said target URL.

6. A method as set forth in claim 5, wherein said encoded web page representation is encoded in HTML.

7. A method as set forth in claim 5, wherein said encoded web page representation is encoded in XML.

8. A method as set forth in claim 5, wherein said web browser periodically checks all URLs associated with bookmarks stored by said browser, to determine if any of said URLs have an alternative bookmark directive associated therewith and, if so, causing said web browser to bookmark said alternative URL instead of the target URL.

9. A computer program product causing a web browser to bookmark an alternative URL rather than a target URL, comprising the step of:
inserting an alternative bookmark directive in an encoded web page representation associated with said target URL, said alternative bookmark directive causing said web browser to bookmark said alternative URL instead of said target URL when a user of said web browser attempts to bookmark said target URL.

10. A computer program product as set forth in claim 9, wherein said encoded web page representation is encoded in HTML.

11. A computer program product as set forth in claim 9, wherein said encoded web page representation is encoded in XML.

12. A computer program product as set forth in claim 9, wherein said web browser periodically checks all URLs associated with bookmarks stored by said browser to determine if any of said URLs have an alternative bookmark directive associated therewith and, if so, causing said web browser to bookmark said alternative URL instead of the target URL.

13. A system causing a web browser to bookmark an alternative URL rather than a target URL, comprising the step of:
inserting an alternative bookmark directive in an encoded web page representation associated with said target URL, said alternative bookmark directive causing said web browser to bookmark said alternative URL instead of said target URL when a user of said web browser attempts to bookmark said target URL.

14. A system as set forth in claim 13, wherein said encoded web page representation is encoded in HTML.

15. A system as set forth in claim 13, wherein said encoded web page representation is encoded in XML.

16. A system as set forth in claim 13, wherein said web browser periodically checks all URLs associated with bookmarks stored by said browser to determine if any of said URLs have an alternative bookmark directive associated therewith and, if so, causing said web browser to bookmark said alternative URL instead of the target URL.
